(19) United States
(12) Patent Application Publication
(10) Pub. No.: US 2007/0158530 A1
(43) Pub. Date: Jul. 12, 2007

(54) Electric screen

(75) Inventors: Hung-Chieh Huang, Miao Li County (TW); Wen-Hao Chang, Taipei Hsien (TW); Wei-Jen Cheng, Miao Li County (TW)

Correspondence Address: BIRCH STEWART KOLASCH & BIRCH, PO BOX 747, FALLS CHURCH, VA, 22040-0747, US

(73) Assignee: Coretronic Corporation

(21) Appl. No.: 11/604,365

(22) Filed: Nov. 27, 2006

(30) Foreign Application Priority Data
Jan. 12, 2006 (TW) 95101257

(51) Int. Cl. G01J 1/44

(52) U.S. Cl. 250/206

(57) ABSTRACT

An electric screen for a projector is provided. The electric screen utilizes a photo-electric conversion apparatus to convert received photon energy into electric energy and stores the electric energy in a storage battery. A motor is driven by the electric energy stored in a storage battery to extend or retract a screen. The electric screen further has a switch, the electric screen cooperates with the projector more efficiently.

### BACKGROUND OF THE INVENTION

(1) Field of the Invention

The present invention generally relates to an electric screen, and particularly to an electric screen used as a screen for a projector.

(2) Description of the Prior Art

Please refer to FIG. 1. FIG. 1 illustrates a conventional electric screen 2. The conventional electric screen 2 includes a long case 4, a power cord 5, a motor 6, a pivot 8 and a screen 9. The long case 4 has a long opening 402 along a long edge D1. The pivot 8 and the motor 6 are disposed in the long case 4. The pivot 8 is directly connected to the motor 6, and the pivot 8 is driven by the motor 6. The motor 6 is electrically connected to the power cord 5. The power cord 5 extends outside the long case 4 from a part of the motor 6 which is connected to the power cord 5. The power cord 5 is connected to an outer socket to receive electric energy. The electric screen 2 utilizes the electric energy provided by the power cord 5 to drive the motor 6. One end of the screen 9 is connected to the pivot 8. The screen 9 extends and retracts through the rotation of the pivot 8, so that the screen 9 is stored in the long case 4 or extend outside the long case 4.

However, the electric screen 2 is electrically connected to the power cord 5 to provide the external electric energy. Meanwhile, the electric screen 2 has to be installed according to the location of the socket. Therefore, the installation and movement of the electric screen 2 are limited. Moreover, the extension and retraction of the screen 9 of the electric screen 2 need to be controlled manually, the automation of the electric screen 2 is insufficient. Besides, when the power cord 5 is not arranged in order, the disordered power cord 5 is untidy.

### SUMMARY OF THE INVENTION

An objective of the present invention is to provide an electric screen to improve the convenience of the installation and movement of the electric screen.

Another objective of the present invention is to provide an electric screen converting photon energy into electric energy to be a power source of the electric screen in order to save the power supply.

The present invention relates to an electric screen used as a screen for a projector. The electric screen includes a photo-electric conversion apparatus, a storage battery, a motor, a pivot, a long case, a switch and a screen. The photo-electric conversion apparatus is used for converting the received photon energy into electric energy. The storage battery is electrically connected to the photo-electric conversion apparatus. The electric energy converted by the photo-electric conversion apparatus is stored in the storage battery. The motor is electrically connected to the storage battery and driven by the electric energy stored in the storage battery. The pivot is connected to the motor and driven by the motor to rotate. The long case has a long opening along a long edge. The pivot is disposed in the long case. One end of the screen is connected to the pivot. The screen extends and retracts through the rotation of the pivot, so that the screen is stored in the long case or extends outside the long case. The photo-electric conversion apparatus is preferably disposed on the long case facing a light beam of an image provided by a projector. As a result, the photo-electric conversion apparatus receives the light beam of the image directly and convert the photon energy of the light beam of the image into electric energy for the electric screen. Therefore, there is no need for outer power source, and the power supply is saved. The switch is electrically connected between the motor and the storage battery. The switch is actuated by receiving photon energy, such as a photo sensor. The switch can also be activated by an electric signal from the photo-electric conversion apparatus.

These and other objectives of the present invention will no doubt become obvious to those of ordinary skill in the art after reading the following detailed description of the preferred embodiment which is illustrated in the various figures and drawings.

### BRIEF DESCRIPTION OF THE DRAWINGS

The present invention will now be specified with reference to its preferred embodiment illustrated in the drawings, in which

FIG. 1 illustrates a conventional electric screen;

FIG. 2 illustrates an appearance of an electric screen according to the present invention;

FIG. 3 illustrates relation among functional modules of the electric screen according to the present invention;

FIG. 4 illustrates a switch according to a first embodiment of the present invention;

FIG. 5 illustrates a switch according to a second embodiment of the present invention;

FIG. 6 illustrates the electric screen with a supplementary power source according to the present invention; and

FIG. 7 illustrates the combination of the electric screen and a curtain system according to the present invention.

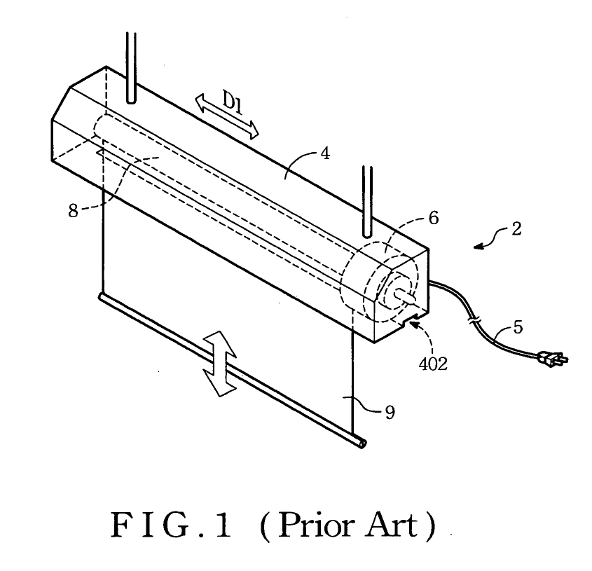

### DESCRIPTION OF THE PREFERRED EMBODIMENT

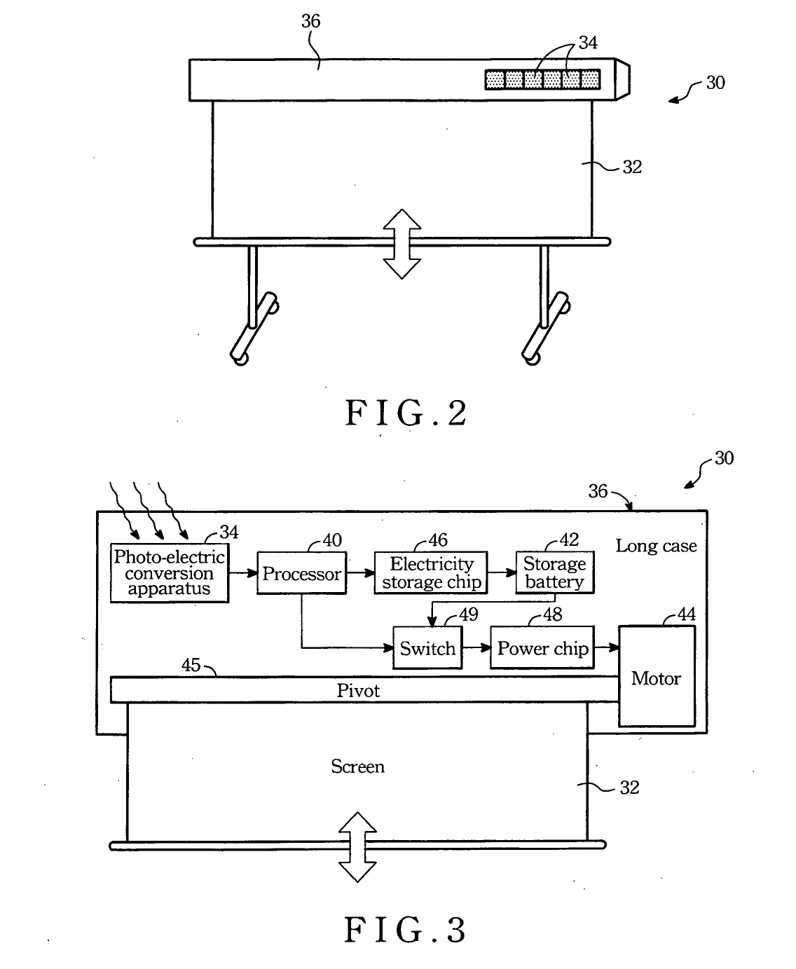

Please refer to FIG. 2 and FIG. 3. The present invention relates to an electric screen 30 used as a screen for a projector. The electric screen 30 includes a photo-electric conversion apparatus 34, a processor 40, a storage battery 42, a motor 44, a pivot 45, an electricity storage chip 46, a power chip 48, a long case 36, a switch 49, and a screen 32. The photo-electric conversion apparatus 34 is used for receiving photon energy and then convert the received photon energy into electric energy. The photo-electric conversion apparatus 34 can be a solar panel or a photo diode. The storage battery 42 is electrically connected to the photo-electric conversion apparatus 34 through the processor 40 and the electricity storage chip 46. The electric energy converted by the photo-electric conversion apparatus 34 is controlled by the processor 40 and is stored in the storage battery 42 by the electricity storage chip 46.

The motor 44 is respectively electrically connected to the storage battery 42 and the processor 40 through the power chip 48 and the switch 49. The electric energy stored in the storage battery 42 is controlled by the switch 49. And then, the motor 44 is driven by the electric energy through the power chip 48.

The processor 40 is electrically connected to the photo-electric conversion apparatus 34. The processor 40 is also electrically connected to the storage battery 42 through the electricity storage chip 46. Additionally, the processor 40 is electrically connected to the motor 44 through the switch 49 and the power chip 48. The processor 40 is used for controlling the electric energy generated by the photo-electric conversion apparatus 34. The processor 40 is also used for controlling the transmission of related electric signals. The switch 49 is electrically connected between the processor 40 and the power chip 48, for activating the power chip 48 to drive the motor 44.

The electricity storage chip 46 is electrically connected between the storage battery 42 and the processor 40, for receiving the electric energy from the photo-electric conversion apparatus 34. Through the control of the processor 40, the electric energy is stored in the storage battery 42 by the electricity storage chip 46. The power chip 48 is electrically connected between the motor 44 and the switch 49. Though the control of the processor 40, the stored electric energy is transmitted to the power chip 48 to drive the motor 44.

The long case 36 has a long opening along a long edge. The pivot 45 is disposed in the long case 36 and directly connected to the motor 44. The pivot 45 is driven to rotate by the rotation of the motor 44. One end of the screen 32 is connected to the pivot 45. The screen 32 extends and retracts through the rotation of the pivot 45, so that the screen 32 is stored in the long case 36 or extends outside the long case 36. The photo-electric conversion apparatus 34 is disposed on the long case 36 and preferably faces the projector. Therefore, the photo-electric conversion apparatus 34 receives a light beam of an image provided by the projector and then converts the photon energy of the light beam of the image into electric energy for the electric screen 30. The photo-electric conversion apparatus 34, the processor 40, the storage battery 42, the motor 44, the electricity storage chip 46, the power chip 48 and the switch 49 can be disposed on or inside the long case 36. Therefore, the appearance of the electric screen 30 is only shown as the long case 36 (as shown in FIG. 2). There is no need for a power cord and a outer socket to supply electric energy. As a result, it is convenient to move the electric screen 30.

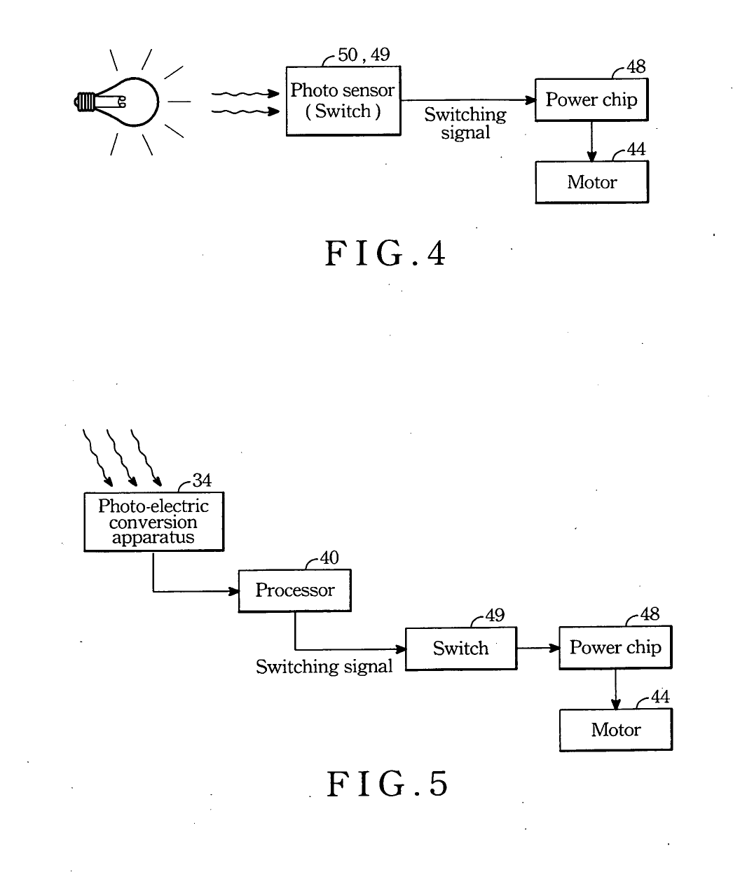

Please further refer to FIG. 4. FIG. 4 illustrates the switch 49 according to a first embodiment of the present invention. The switch 49 is a photo sensor 50 receiving the photon energy around the electric screen 30 to generate a switching signal to the power chip 48. The motor 44 is driven by the power chip 48. The electric energy stored in the storage battery 42 is directly transmitted to the switch 49. And the switching signal is sent by the switch 49 to the power chip 48, so that the motor 44 is driven by the power chip 48. Please refer to FIG. 5. FIG. 5 illustrates the switch 49 according to a second embodiment of the present invention. The processor 40 outputs a switching signal to the switch 49 according to the electric energy generated by the photo-electric conversion apparatus 34. The signal is transmitted to the power chip 48 by the switch 49, so that the motor 44 is driven by the power chip 48. In the embodiment in FIG. 4 or FIG. 5, when the projector is warming up or operating, the light beam of the image projected by the projector emits to the photo-electric conversion apparatus 34. And then, the switch 49 sends a signal to the power chip 48, so that the motor 44 is driven by the power chip 48. As a result, the screen 32 of the electric screen 30 is scrolled down automatically. When the projector is turned off, the photo-electric conversion apparatus 34 senses no photon energy provided by the light beam of the image provided by the projector. The switch 49 also sends a signal to the power chip 48, so that the motor 44 is driven by the power chip 48. As a result, the screen 32 is scrolled up and stored in the long case 36. In another embodiment, when the projector is operating and the light in the conference room is turned off, the photo sensor 50 sense the change of photon energy in the conference room. Then, the photo sensor 50 sends a switching signal to the power chip 48, so that the motor 44 is driven by the power chip 48. As a result, the screen 32 of the electric screen 30 is scrolled down automatically. After the light of the conference is turned on, the photo sensor 50 senses the change of the photo energy in the conference room. Then, the photo sensor 50 sends a switching signal to the power chip 48, so that the motor 44 is driven by the power chip 48. As a result, the screen 32 is stored in the long case 36 automatically.

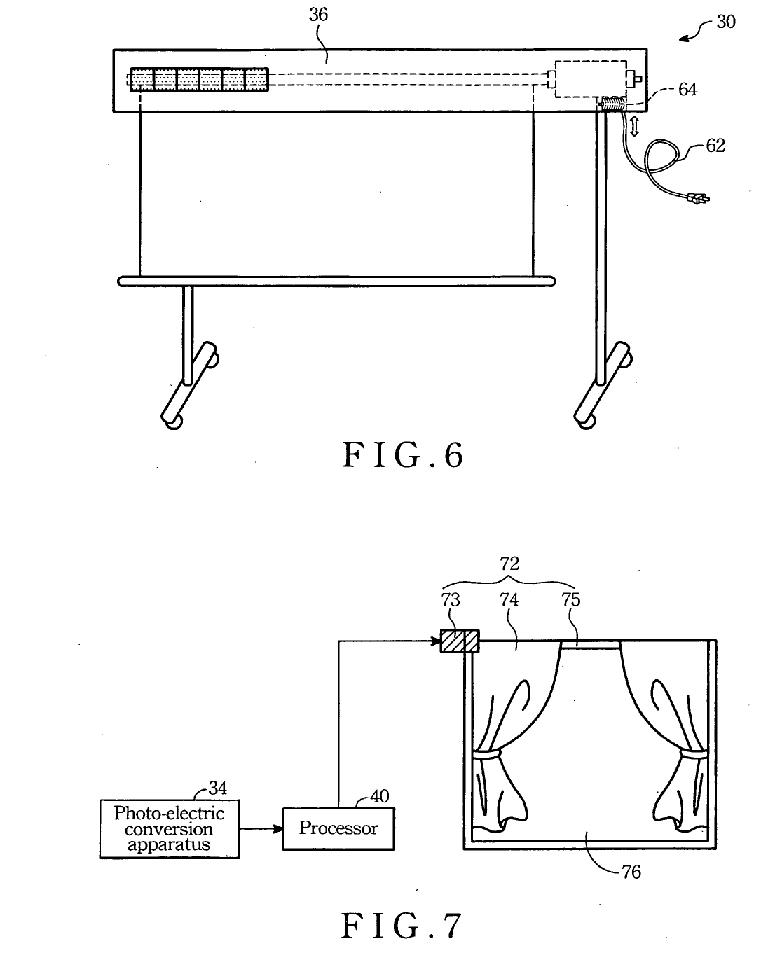

Please further refer to FIG. 6. FIG. 6 illustrates the electric screen 30 with a supplementary power source according to the present invention. The electric screen 30 of the present invention further include a supplementary power source. When the electric energy of the storage battery 42 is insufficient, the supplementary power source provides the electric energy for the electric screen 30. The supplementary power source includes a power cord 62 and a power cord storage apparatus 64. The power cord storage apparatus 64 is disposed in the long case 36 for storing the power cord 62 and for extending the power cord 62 outside the long case 36. When the electric energy of the storage battery 42 is insufficient, the power cord 62 is pulled out from the power cord storage apparatus 64 and outside the long case 36. The power cord 62 is electrically connected to a outer socket to provide the electric energy for the electric screen 30.

Please refer to FIG. 7. FIG. 7 illustrates the combination of the electric screen and a curtain system according to the present invention. The electric screen 30 of the present invention further includes a curtain system 72. The curtain system 72 includes a curtain 74, a track 75 and a motor 73. The motor 73 is electrically connected to the processor 40 to control the motor 73, so that the curtain 74 is driven by the motor 73 to move along the track 75. When the projector is turned on and the light beam of the image provided by the projector is emitted to the photo-electric conversion apparatus 34, the photo-electric conversion apparatus 34 generates an electric signal to the processor 40. Through the processor 40, the curtain 74 is driven by the motor 73 to move along the track 75. As a result, the curtain 74 covers the window 76, and the space where the projector is operated becomes a dark room. Therefore, it is convenient to operate the projector without operating the curtain system 72 manually.

As stated above, the electric screen 30 of the present invention utilizes the photo-electric conversion apparatus 34 to convert photon energy into electric energy for the electric screen 30. Therefore, there is no need for outer power source. As a result, the power supply is saved. Furthermore, the disadvantage of the untidiness of the conventional power cord is improved. And the limitation in the environment of the conventional electric screen is avoided. When the electric screen is operated in coordination with the switch, the electric screen can cooperate with the projector more efficiently. For example, when the projector is operated, the extension and retraction of the screen can be controlled by the switch through sensing photon energy. Furthermore, the appearance of the electric screen 30 of the present invention is only shown as the long case 36, and there is no need for a power cord and a outer socket to supply electric energy. Therefore, it is convenient to move the electric screen 30.

With the example and explanations above, the features and spirits of the invention are hopefully well described. Those skilled in the art will readily observe that numerous modifications and alterations of the device may be made while retaining the teaching of the invention. Accordingly, the above disclosure should be construed as limited only by the metes and bounds of the appended claims.

We claim:

1. An electric screen comprising:
a photo-electric conversion apparatus for receiving photon energy and converting the photon energy into electric energy;
a storage battery electrically connected to the photo-electric conversion apparatus for storing the electric energy;
a motor electrically connected to the storage battery and driven by the electric energy stored in the storage battery;
a pivot connected to the motor and driven to rotate by the motor; and
a screen, one end of the screen connected to the pivot, the screen extending and retracting through the rotation of the pivot.

2. The electric screen of claim 1, wherein the photo-electric conversion apparatus is a solar panel.

3. The electric screen of claim 1, wherein the photo-electric conversion apparatus is a photo diode.

4. The electric screen of claim 1 further comprising a processor electrically connected to the photo-electric conversion apparatus, the storage battery and the motor, wherein the photo-electric conversion apparatus, the storage battery, and the motor are controlled by the processor.

5. The electric screen of claim 4 further comprising a switch, wherein the switch is electrically connected between the processor and the motor for transmitting a signal to the motor to drive the motor.

6. The electric screen of claim 5, wherein the processor outputs a switching signal to the switch according to the electric energy generated by the photo-electric conversion apparatus, after receiving the switching signal, the switch transmitting the switching signal to the motor.

7. The electric screen of claim 6, wherein the photon energy received by the photo-electric conversion apparatus comes from photon energy of a light beam of an image provided by a projector.

8. The electric screen of claim 4 further comprising a curtain system electrically connected to the processor, wherein the processor is used for receiving an electric signal to control the movement of the curtain of the curtain system, for covering/uncovering a window.

9. The electric screen of claim 1 further comprising a switch electrically connected to the motor, wherein the switch is a photo sensor used for receiving environmental photon energy to generate a switching signal, the switching signal transmitted to the motor to drive the motor.

10. The electric screen of claim 1 further comprising a case, wherein the case has an opening, the pivot disposed in the case, and the screen extending outside the case through the opening.

11. The electric screen of claim 10 further comprising a supplementary power source, wherein the supplementary power source comprises a power cord and a power cord storage apparatus, the power cord storage apparatus disposed in the case for storing the power cord.

12. The electric screen of claim 10, wherein the photo-electric conversion apparatus is disposed on the case and faces a projector, for receiving photon energy of a light beam of an image provided by the projector.

13. The electric screen of claim 10, wherein the storage battery and the motor are disposed on or inside the case.

14. The electric screen of claim 1, wherein the electric screen is used as a screen for a projector.

15. The electric screen of claim 1, wherein the photon energy comes from a light beam of an image provided by a projector.

16. The electric screen of claim 1 further comprising a case, wherein the case is used for containing the photo-electric conversion apparatus, the storage battery, the motor, the pivot, and the screen.
